(19) United States
(12) Patent Application Publication
(10) Pub. No.: US 2018/0297575 A1
(43) Pub. Date: Oct. 18, 2018

(54) ENERGY RECOVERY SYSTEM

(71) Applicant: Caterpillar Underground Mining Pty. Ltd., South Burnie (AU)

(72) Inventor: Alexander E. Dowling, Burnie (AU)

(73) Assignee: Caterpillar Underground Mining Pty. Ltd., South Burnie (AU)

(21) Appl. No.: 15/488,541

(22) Filed: Apr. 17, 2017

(51) Int. Cl. B60W 20/00; B60L 15/20

(52) U.S. Cl. CPC B60W 20/00; B60L 15/20; B60W 2520/16; B60Y 2300/18125; B60P 1/16; B60Y 2200/92; B60W 2300/17; B60L 2240/42; Y10S 903/903

(57) ABSTRACT

A mining machine is provided. The mining machine includes a frame. The mining machine includes an engine mounted on the frame. The mining machine also includes a transmission unit operably coupled to the engine. The mining machine further includes an electric drive operably coupled to the transmission unit. The electric drive is adapted to operate as an electric motor in a first operating mode of the machine to provide electric power to the mining machine. The electric drive is also adapted to operate as an electric generator in a second operating mode of the machine to generate electric power for later use.

### TECHNICAL FIELD

The present disclosure relates to an energy recovery system. More specifically, the present disclosure relates to the energy recovery system for an engine associated with a machine.

### BACKGROUND

Machines, such as haul trucks employed in underground mining applications, may repeatedly travel along a downward slope and an upward slope during a work cycle. During travel along the downward slope, the speed of the machine may be controlled through braking, which may lead to increased brake wear, increased braking noise, wasted energy in the form of heat due to friction, and so on.

During travel along the upward slope, a power output of the engine may be maximized, especially when hauling material. The increased power output may in turn result in higher fuel consumption, lower efficiency, frequent gear hunting, increased engine noise, increased emission, and so on. For underground mining applications, higher emissions may not be desirable due to strict controls on ventilation and exhaust emissions from combustion power sources.

Generally, an energy recovery system may be employed in such a machine in order to regenerate braking energy and/or provide the regenerated energy back to the engine during higher power demands. However, such an energy recovery system may have a fixed power capacity which may not be optimized for a current work cycle of the machine. For example, the energy recovery system may have either a higher or lower capacity than required based on the current work cycle of the machine. As a result, the energy recovery system may add unnecessary weight/burden to the existing system in turn lowering system efficiency and cost effectiveness. Hence, there is a need for an improved energy recovery system.

U.S. Pat. No. 6,170,587 describes a hybrid propulsion system for use in road vehicle operations. The propulsion system includes a power splitting mechanical transmission for coupling to a tail shaft of the vehicle. The propulsion system includes a first drive unit arranged for regenerative operation and coupled to the power splitting mechanical transmission. The propulsion system includes a second drive unit arranged for regenerative operation and coupled, independently of the first drive unit, to the power splitting mechanical transmission. The propulsion system also includes a non-regenerative third drive unit for coupling, in parallel to the power splitting mechanical transmission, to the tail shaft. The propulsion system further includes a propulsion control system for coordinating operation of the drive units in accordance with a plurality of predetermined modes corresponding to a drive cycle of the vehicle.

### SUMMARY OF THE DISCLOSURE

In an aspect of the present disclosure, a mining machine is provided. The mining machine includes a frame. The mining machine includes an engine mounted on the frame. The mining machine also includes a transmission unit operably coupled to the engine. The mining machine further includes an electric drive operably coupled to the transmission unit. The electric drive is adapted to operate as an electric motor in a first operating mode of the machine to provide electric power to the mining machine. The electric drive is also adapted to operate as an electric generator in a second operating mode of the machine to generate electric power for later use.

In another aspect of the present disclosure, an energy recovery system for a machine is provided. The machine includes an engine and a transmission unit operably coupled thereto. The energy recovery system includes at least one electric drive operably coupled to the transmission unit. The energy recovery system also includes a power storage module electrically coupled to the at least one electric drive. The energy recovery system further includes a controller communicably coupled to the at least one electric drive. The controller is configured to receive a signal indicative of an operating mode of the machine. The controller is also configured to generate an excitation frequency based, at least in part, on the operating mode of the machine. The controller is further configured to control the at least one electric drive to selectively operate as an electric motor configured to provide torque to the transmission unit to assist with machine propulsion, and an electric generator configured to generate electric power based, at least in part, on the generated excitation frequency.

In yet another aspect of the present disclosure, a mining machine is provided. The mining machine includes a frame. The mining machine includes an engine mounted on the frame. The mining machine also includes a first electric drive operably coupled to the engine. The mining machine further includes a second electric drive operably coupled to the first electric drive. The first electric drive and the second electric drive is adapted to operate as an electric motor in a first operating mode of the machine to provide electric power to the mining machine. The first electric drive and the second electric drive is also adapted to operate as an electric generator in a second operating mode of the machine to generate electric power for later use.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a schematic representation of an energy recovery system for the machine of FIG. 1, according to one embodiment of the present disclosure;

FIG. 3 is partial cross sectional perspective view of exemplary electric drives of the energy recovery system of FIG. 2, according to one embodiment of the present disclosure; and

FIG. 4 is a flowchart of a method of working of the energy recovery system, according to one embodiment of the present disclosure.

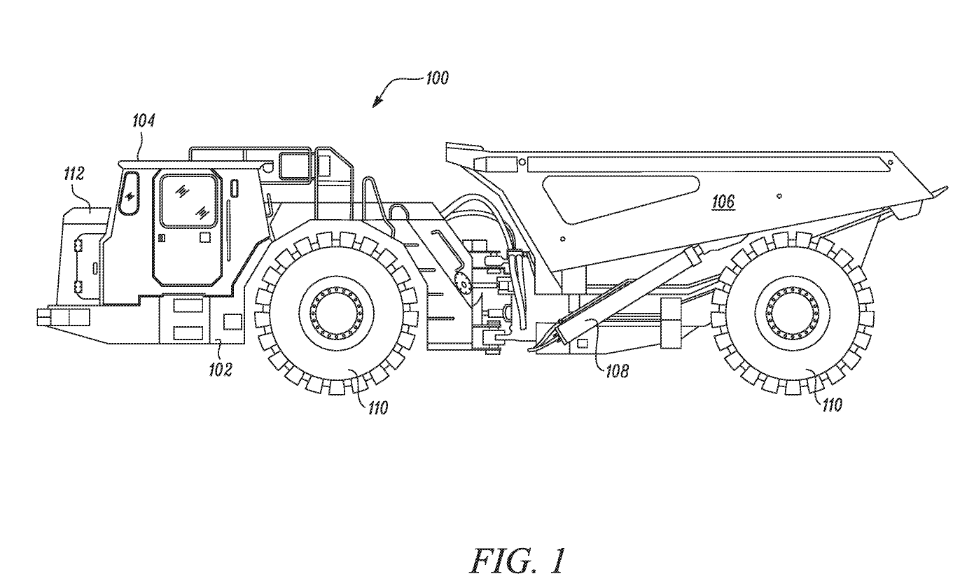

### DETAILED DESCRIPTION

Wherever possible, the same reference numbers will be used throughout the drawings to refer to the same or the like parts. Referring to FIG. 1, an exemplary machine 100 is illustrated. In the illustrated embodiment, the machine 100 is an articulated mining truck. The machine 100 is adapted for mining applications and to transport material, such as ore, soil, rocks, and so on from one location to another. In certain embodiments, the machine 100 may be particularly suited for underground mining operations. In other embodiments, the machine 100 may be any other machine such as an off-highway truck, a haul truck, a dozer, a wheel loader, a Load Haul Dump (LHD) loader, a locomotive, and so on. The machine 100 may be any machine related to an industry including, but not limited to, construction, transportation, mining, material handling, forestry, agriculture, and waste management.

The machine 100 includes a frame 102. The frame 102 is adapted to support various components of the machine 100. The machine 100 includes an operator cabin 104 mounted on the frame 102. The operator cabin 104 is adapted to house one or more controls, such as, for example, a steering input device, a pedal to cause acceleration or braking, a lever, a control console, one or more switches, buttons, knobs, audio visual system, alarm system, and so on. The controls are adapted to operate and control the machine 100 on ground.

The machine 100 includes a load bed 106 provided on the frame 102. The load bed 106 is adapted to load and unload material therefrom for transporting the material from one location to another. The machine 100 also includes one or more hydraulic cylinders 108 coupled between the frame 102 and the load bed 106. The hydraulic cylinders 108 are adapted to tilt the load bed 106 during unloading of the material. The machine 100 also includes a set of wheels 110 mounted to the frame 102. The wheels 110 are adapted to support and provide mobility to the machine 100 on the ground.

The machine 100 further includes an enclosure 112 provided on the frame 102. The enclosure 112 is adapted to house a power source (not shown) of the machine 100. The power source is adapted to provide power to the machine 100 for operational and mobility requirements. The power source may be a combination of one or more power sources known in the art, such as an internal combustion engine, an electric drive, a power storage module, and so on, and will be explained in more detail later. Additionally, the enclosure 112 may also house various components and systems of the machine 100 therein such as, a transmission system, a drive control system, a lubrication system, an engine control system, a cooling system, an air supply system, and so on.

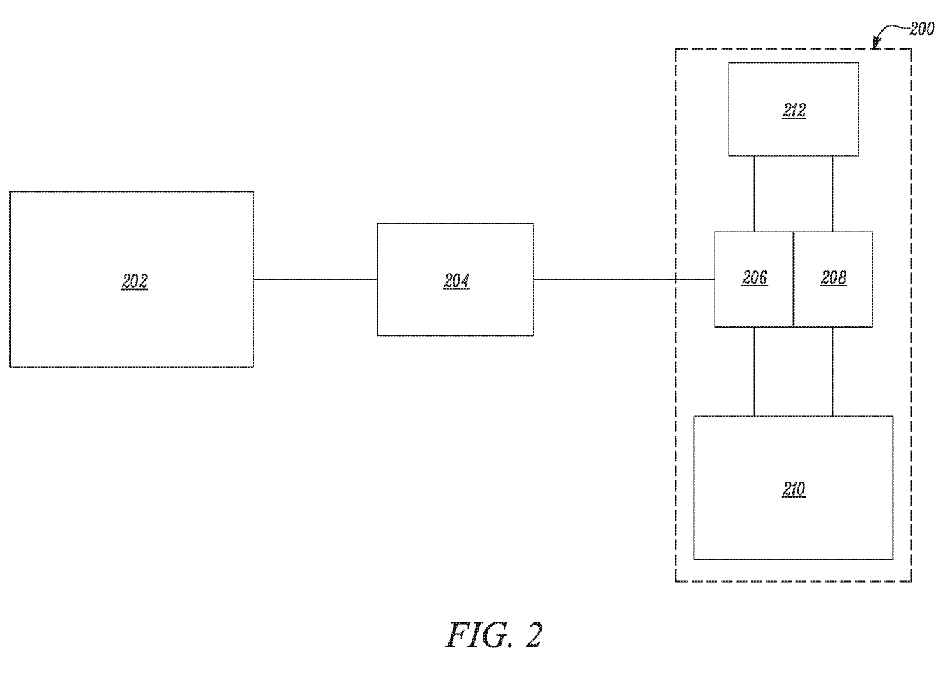

The present disclosure relates to an energy recovery system 200 for the machine 100. Referring to FIG. 2, a schematic representation of the energy recovery system 200 is illustrated. The energy recovery system 200 is operably coupled to an engine 202 associated with the machine 100 via a transmission unit 204. The transmission unit 204 may be any transmission unit known in the art, such as a manual transmission, an automatic transmission, and so on. Also, the engine 202 may be any internal combustion engine known in the art powered by any fuel, such as gasoline, diesel, natural gas, and/or a combination thereof.

The energy recovery system 200 includes at least one electric drive operably coupled to the transmission unit 204. In the illustrated embodiment, the energy recovery system 200 includes a plurality of electric drives, such as a first electric drive 206 and a second electric drive 208 operably coupled to the transmission unit 204. It is also contemplated that in other embodiments the first electric drive 206 and the second electric drive 208 may be directly coupled to the engine 202. In such a situation, the first electric drive 206 may be operably coupled to any power take-off associated with the engine 202, such as a pump interface, a compressor interface, a gear drive, and other mechanical interfaces where torque can be added.

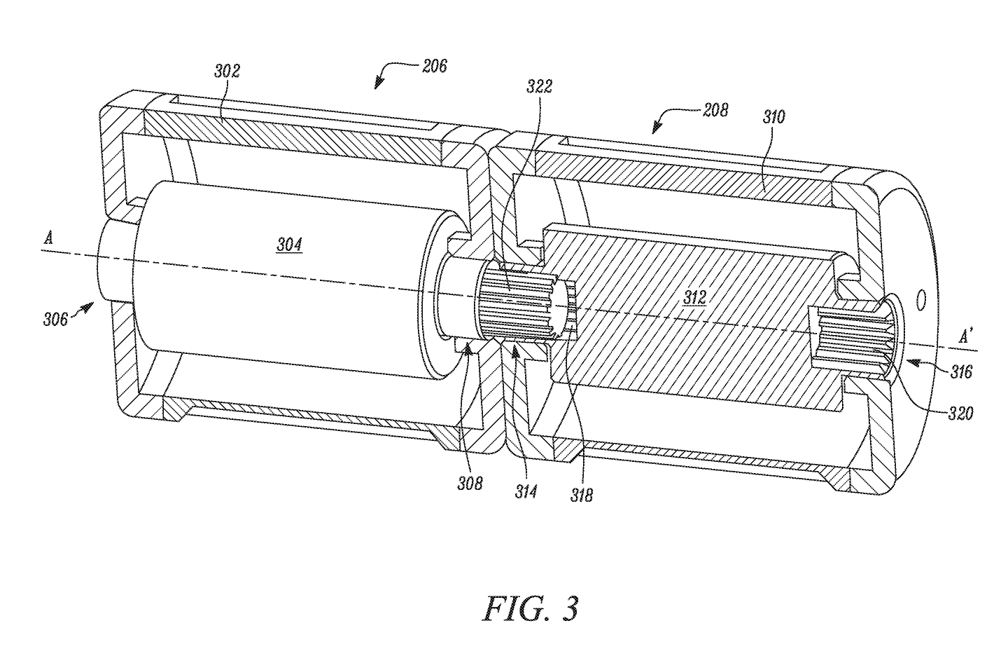

Referring to FIG. 3, an exemplary mechanical coupling between the first electric drive 206 and the second electric drive 208 is illustrated. The first electric drive 206 and the second electric drive 208 are operably coupled to one another in a series configuration. The first electric drive 206 includes a first housing 302 and a first rotor 304. The first rotor 304 includes a first end 306 and a second end 308 axially opposite the first end 306. The first rotor 304 is rotatably supported within the first housing 302 via the first end 306 and the second end 308 thereof. Also, each of the first end 306 and the second end 308 include a hollow configuration having an internal spline (not shown) respectively.

Similarly, the second electric drive 208 includes a second housing 310 and a second rotor 312. The second rotor 312 includes a first end 314 and a second end 316 axially opposite the first end 314. The second rotor 312 is rotatably supported within the second housing 310 via the first end 314 and the second end 316 thereof. Also, each of the first end 314 and the second end 316 include a hollow configuration having an internal spline 318, 320 respectively.

In order to provide mechanical coupling between the first electric drive 206 and the second electric drive 208, the first electric drive 206 is arranged adjacent to the second electric drive 208 in a manner such that the first rotor 304 is axially aligned along an axis A-A′ with respect to the second rotor 312. Further, a splined shaft 322 is slidably coupled with the internal spline of second end 308 of the first rotor 304 and the internal spline 318 of the first end 314 of the second rotor 312. Similarly, another splined shaft (not shown) may be employed to couple additional electric drives to the first end 306 of the first rotor 304 and/or the second end 316 of the second rotor 312. The splined shaft 322 provides mechanical coupling and transfer of power between the first electric drive 206 and the second electric drive 208.

In other embodiments, the first electric drive 206 and the second electric drive 208 may be operably coupled to one another in a parallel configuration without limiting the scope of the disclosure. The first electric drive 206 and the second electric drive 208 may be operably coupled to one another in the parallel configuration using any known mechanical coupling methods (not shown), such as one or more gear drives, clutches, belt drive pulleys, and so on. Further, in other embodiments, the energy recovery system 200 may include a single electric drive or additional electric drives (not shown), such as a third electric drive, a fourth electric drive, and so on similar to the first electric drive 206 and the second electric drive 208. The third electric drive, the fourth electric drive, and so on may be operably coupled to one another and the first electric drive 206 and/or the second electric drive 208 in the series configuration, the parallel configuration, or a combination thereof.

The first electric drive 206 and the second electric drive 208 may be electrically coupled to one another in a series configuration or a parallel configuration based on application requirements. For example, to maintain a voltage constant throughout the system, the first electric drive 206 and the second electric drive 208 may be electrically coupled in the parallel configuration. In a particular embodiment, and in order to split the voltage across the system, the first electric drive 206 and the second electric drive 208 may be electrically coupled in the series configuration. Also, a bus bar (not shown) may be employed for providing electrical connection between the first electric drive 206 and the second electric drive 208. The bus bar may be further used for electrically coupling additional electric drives to the system.

Each of the first electric drive 206 and the second electric drive 208 may be any electric drive known in the art including, but not limited to, Alternating Current (AC) drives, including induction and synchronous AC motors, Direct Current (DC) drives, and/or a combination thereof. More specifically, in the illustrated embodiments, each of the first electric drive 206 and the second electric drive 208 is a Variable Frequency Drive (VFD). Accordingly, each of the first electric drive 206 and the second electric drive 208 is adapted to selectively operate as an electric motor and an electric generator based on an operating mode of the machine 100 and will be explained in more detail later.

Referring to FIG. 2, the energy recovery system 200 also includes a power storage module 210 electrically coupled to the at least one electric drive. More specifically, in the illustrated embodiment, the power storage module 210 is electrically coupled to the first electric drive 206 and the second electric drive 208. The power storage module 210 is configured to selectively supply and store electric power based, at least in part, on the operating mode of the machine 100 and will be explained in more detail later.

The operating modes of the machine 100 may vary based on application requirements. For example, in the illustrated embodiment, the operating mode of the machine 100 may be a first operating mode relating to a travel of the machine 100 along an upward incline. In such a situation, the machine 100 may be traveling the upward incline with or without material present within the load bed 106. Irrespective, the machine 100 may require additional torque delivery from the engine 202 in order to provide enough power for the machine 100 to travel the upward incline.

Also, in the illustrated embodiment, the operating mode of the machine 100 may be a second operating mode relating to retarding of the machine 100. In such a situation, the machine 100 may be traveling a downward incline with or without material present within the load bed 106. Irrespective, the machine 100 may require retarding force in the form of brake application and/or engine braking in order to provide enough braking power for the machine 100 to travel the downward incline in a controlled manner.

The energy recovery system 200 further includes a controller 212. The controller 212 is communicably coupled to the at least one electric drive. More specifically, in the illustrated embodiment, the controller 212 is communicably coupled to the first electric drive 206 and the second electric drive 208. The controller 212 is configured to receive a signal indicative of the operating mode of the machine 100. The controller 212 is also configured to generate an excitation frequency based, at least in part, on the operating mode of the machine 100. The controller 212 is further configured to control the at least one electric drive to selectively operate as an electric motor and an electric generator based, at least in part, on the generated excitation frequency and will be explained in more detail later.

In the illustrated embodiment, the controller 212 is a Variable Frequency Controller (VFC). In such a situation, the controller 212 is dedicatedly configured to perform functions related to the energy recovery system 200. In other embodiments, the controller 212 may be a Machine Control Unit (MCU) associated with the machine 100. In such a situation, the controller 212 may be configured to perform functions related to the energy recovery system 200 in addition to various other machine control functions known in the art.

### INDUSTRIAL APPLICABILITY

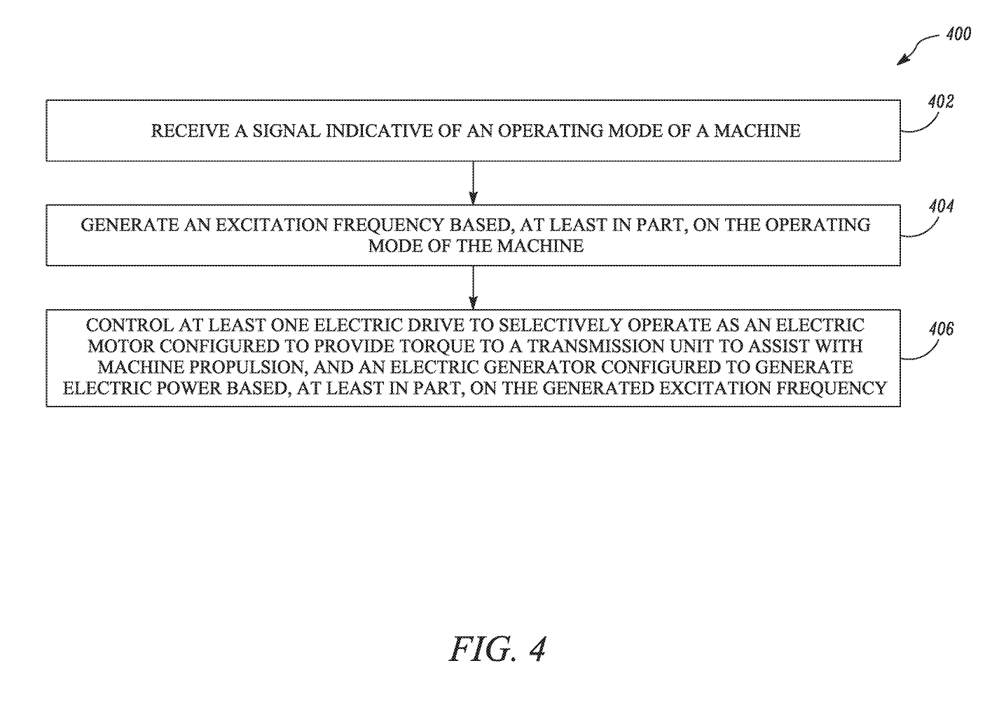

The present disclosure relates to a method 400 of working of the energy recovery system 200. Referring to FIG. 4, a flowchart of the method 400 is illustrated. At step 402, the controller 212 receives the signal indicative of the operating mode of the machine 100, such as the first operating mode and the second operating mode. In one embodiment, the controller 212 may receive the signal indicative of the operating mode of the machine 100 based on an operator input. More specifically, the operator may provide the input related to the first operating mode or the second operating mode of the machine 100 through the control console within the operator cabin 104, such as through a switch, a display unit, a joystick, and so on.

In another embodiment, the controller 212 may receive the signal indicative of the operating mode of the machine 100 based on various operating parameters of the machine 100/engine 202. The operating parameters may include one or more operating parameters of the engine 202, but not limited to, an engine speed, an engine power output, an engine load, an intake manifold pressure, an exhaust manifold pressure, a cylinder pressure, an engine valve position, an intake air temperature, an exhaust gas temperature, and an engine temperature. The operating parameters may also include one or more operating parameters of the transmission unit 204 including, but not limited to, a position of the transmission unit 204 indicating a current gear position, an output speed of the transmission unit 204 such as a driveshaft speed, and known shift points of the transmission unit 204 based on various operating parameters of the engine 202.

The operating parameters may also include one or more operating parameters of the machine 100 including, but not limited to, a dedicated operator input indicating activation of retarding control for the machine 100, a throttle position, a brake position, a ground speed of the machine 100, an operating status of one or more implements such as the load bed 106 of the machine 100, a haul weight, one or more sensor inputs such as an inclinometer input indicating inclination of the machine 100 with respect to the ground, a location of the machine 100 on a mapped travel path such as through a Global Positioning System (GPS) position of the machine 100 travelling on the ground, static architecture inputs such as Radio Frequency Identification (RFID) tag inputs for the machine 100 traveling inside a mine, and so on. Based on the operating parameters, the controller 212 may identify the operating mode of the machine 100/engine 202 based on any known method, such as a pre stored mathematical expression, a pre stored dataset, and so on.

At step 404, based on the identified operating mode of the machine 100, the controller 212 generates the appropriate excitation frequency. More specifically, based on the identified first operating mode of the machine 100, the controller 212 generates a first excitation frequency. Further, based on the identified second operating mode of the machine 100, the controller 212 generates a second excitation frequency. At step 406, the controller 212 controls the at least one electric drive to selectively operate as the electric motor configured to provide torque to the transmission unit 204 to assist with machine propulsion, and an electric generator configured to generate electric power based, at least in part, on the generated excitation frequency. In certain embodiments, the at least one electric drive may be used to limit shifting of the transmission unit 204 when operating as the electric motor.

More specifically, the first excitation frequency is configured to operate each of the first electric drive 206 and the second electric drive 208 as the electric motor. In such a situation, the power storage module 210 supplies electric power to each of the first electric drive 206 and the second electric drive 208. Accordingly, during the first operating mode of the machine 100, each of the first electric drive 206 and the second electric drive 208 provides additional torque to the engine 202. In such a situation, the additional torque may limit gear hunting or shifting of the transmission unit 204 to one or more subsequent positions in order to maintain the engine 202 in a desired power range required during travel along the upward incline. In other embodiments, the additional torque may be used to shape a power curve of the engine 202 in order to meet desired specifications (e.g. fuel efficiency, power output, etc.).

The second excitation frequency is configured to operate each of the first electric drive 206 and the second electric drive 208 as the electric generator. In such a situation, the power storage module 210 receives electric power from each of the first electric drive 206 and the second electric drive 208. The received electric power is stored within the power storage module 210 for later use by each of the first electric drive 206 and the second electric drive 208 during the first operating mode of the machine 100. Also, during the second operating mode of the machine 100, each of the first electric drive 206 and the second electric drive 208 provides additional rotational mass coupled to the transmission unit 204. This rotational mass provides an additional mass moment of inertia or, more specifically, a resistive torque to the transmission unit 204 during retarding of the engine 202 in turn providing added retarding force to the machine 100.

It should be noted that the first excitation frequency and the second excitation frequency configured to operate each of the first electric drive 206 and the second electric drive 208 as the electric motor and the electric generator respectively described herein is merely exemplary. In other embodiments, each of the first electric drive 206 and the second electric drive 208 may be selectively operated as the electric motor and the electric generator using any other excitation methods known in the art without limiting the scope of the disclosure.

The energy recovery system 200 provides a simple, efficient, and cost effective system for providing additional torque to the engine 202 as and when required, and for storing energy during retarding of the machine 100 to be used later by the engine 202. The energy recovery system 200 may be retrofitted in any machine based on application requirements with little or no modification to the existing components/systems. Also, the energy recovery system 200 provides a scalable solution to alter a capacity thereof based on application requirements.

For example, for large or small capacity engines, higher or smaller capacity electric drives may be employed respectively for cost effectiveness and efficiency. Further, in situations, of higher capacity demands, additional electric drives may be mechanically coupled to the existing electric drives with minimum effort to scale up the system capacity. For example, during work cycles having longer travel times and/or steeper inclines and/or higher haul weights, added number of electric drives may be employed in the system in order to capture and deliver maximum possible energy from and to the engine 202 respectively.

Similarly, during work cycles having shorter travel times and/or gradual inclines and/or lower haul weights, the additional electric drives may be decoupled from the system in order to reduce unnecessary system weight from the machine 100 in turn improving system efficiency and cost. It should be noted that a capacity of the power storage module 210 may also be scaled up or scaled down in relation to that of the electric drives for providing required power storage/delivery capacity. Also, the electric power stored in the power storage module 210 may be alternatively used for other auxiliary systems of the machine 100, thus, providing flexibility for usage of stored power.

In some embodiments, the energy recovery system 200 provides torque to limit gear hunting of the transmission unit 204 during travel of the machine 100 on upward inclines. For example, due to steep inclines and/or haul weight, the engine 202 may require additional power to travel at a required speed. In such a situation, the transmission unit 204 may have to be maintained in a correct position to provide the appropriate power without stalling the engine 202. As a result, in manual transmission systems, the operator may have to constantly operate the transmission unit 204 in order to maintain the engine 202 in the appropriate power band. Alternately, in automatic transmission systems, the transmission unit 204 may be constantly operated and switched to one or more subsequent gear positions in order to maintain the engine 202 in the appropriate power band.

In such a situation, the energy recovery system 200 provides additional torque delivery to the transmission unit 204 and the engine 202 to limit gear shifts and maintain the engine 202 in the appropriate power band. As a result, the engine 202 may be operated at efficient speeds in turn providing reduced fuel consumption, reduced emission, improved fuel efficiency, improved engine health, lower service demands, lower costs, and so on. In underground mining applications, reduced emission may further provide to improve underground mines vent rates and reduce architectural requirements.

Further, during retarding of the machine 100, the electric drives provide the resistive torque to the transmission unit 204. This in turn provides additional retarding force during travel of the machine 100 along the downward incline. As a result, lower braking force may be required in turn providing improved braking efficiency, reduced brake wear, reduced replacement costs, reduced braking noise, reduced cylinder temperature spikes, reduced cooling system load for one or more axles of the machine 100, and so on.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A mining machine comprising:
a frame;
an engine mounted on the frame;
a transmission unit operably coupled to the engine;
an electric drive operably coupled to the transmission unit,
wherein the electric drive is adapted to operate as an electric motor in a first operating mode of the machine to provide electric power to the mining machine, and
wherein the electric drive is adapted to operate as an electric generator in a second operating mode of the machine to generate electric power for later use.

2. The mining machine of claim 1, wherein the electric drive is at least one of an Alternating Current (AC) drive and a Direct Current (DC) drive.

3. The mining machine of claim 1 further includes a power storage module electrically coupled to the electric drive, wherein the power storage module is adapted to:
supply electric power to the electric drive during the first operating mode of the machine, and
store electric power received from the electric drive during the second operating mode of the machine.

4. The mining machine of claim 1, wherein:
in the first operating mode the mining machine is traveling along an upward incline, and
in the second operating mode the mining machine is retarding.

5. The mining machine of claim 1 further includes a controller communicably coupled to the electric drive, wherein the controller is configured to:
generate a first excitation frequency configured to operate the electric drive as the electric motor, and
generate a second excitation frequency configured to operate the electric drive as the electric generator.

6. The mining machine of claim 5, wherein the controller is at least one of a Machine Control Unit (MCU) and a Variable Frequency Controller (VFC).

7. The mining machine of claim 1, wherein a plurality of electric drives are operably coupled to one another in a series configuration.

8. An energy recovery system for a machine, the machine having an engine and a transmission unit operably coupled thereto, the energy recovery system comprising:
at least one electric drive operably coupled to the transmission unit;
a power storage module electrically coupled to the at least one electric drive; and
a controller communicably coupled to the at least one electric drive, the controller configured to:
receive a signal indicative of an operating mode of the machine;
generate an excitation frequency based, at least in part, on the operating mode of the machine; and
control the at least one electric drive to selectively operate as an electric motor configured to provide torque to the transmission unit to assist with machine propulsion, and an electric generator configured to generate electric power based, at least in part, on the generated excitation frequency.

9. The energy recovery system of claim 8, wherein the at least one electric drive includes a plurality of electric drives operably coupled to one another in a series configuration.

10. The energy recovery system of claim 8, wherein the at least one electric drive is an Alternating Current (AC) drive and a Direct Current (DC) drive.

11. The energy recovery system of claim 8, wherein the power storage module is configured to selectively supply and store electric power based, at least in part, on the operating mode of the machine.

12. The energy recovery system of claim 8, wherein the operating mode of the machine includes a torque delivery mode and a retarding mode.

13. The energy recovery system of claim 8, wherein the controller is at least one of a Machine Control Unit (MCU) and a Variable Frequency Controller (VFC).

14. A mining machine comprising:
a frame;
an engine mounted on the frame;
a first electric drive operably coupled to the engine; and
a second electric drive operably coupled to the first electric drive,
wherein each of the first electric drive and the second electric drive is adapted to operate as an electric motor in a first operating mode of the machine to provide electric power to the mining machine, and
wherein each of the first electric drive and the second electric drive is adapted to operate as an electric generator in a second operating mode of the machine to generate electric power for later use.

15. The mining machine of claim 14, wherein each of the first electric drive and the second electric drive is any one of an Alternating Current (AC) drive and a Direct Current (DC) drive.

16. The mining machine of claim 14 further includes a power storage module electrically coupled to each of the first electric drive and the second electric drive, wherein the power storage module is adapted to:
supply electric power to each of the first electric drive and the second electric drive during the first operating mode of the machine, and
store electric power received from each of the first electric drive and the second electric drive during the second operating mode of the machine.

17. The mining machine of claim 14, wherein:
in the first operating mode the mining machine is traveling along an upward incline, and
in the second operating mode the mining machine is retarding.

18. The mining machine of claim 14 further includes a controller communicably coupled to each of the first electric drive and the second electric drive, wherein the controller is configured to:
generate a first excitation frequency configured to operate each of the first electric drive and the second electric drive as the electric motor, and
generate a second excitation frequency configured to operate each of the first electric drive and the second electric drive as the electric generator.

19. The mining machine of claim 18, wherein the controller is at least one of a Machine Control Unit (MCU) and a Variable Frequency Controller (VFC).

20. The mining machine of claim 14, wherein the first electric drive and the second electric drive are operably coupled to one another in a series configuration.
